(19) United States
(12) Patent Application Publication
(10) Pub. No.: US 2025/0343841 A1
(43) Pub. Date: Nov. 6, 2025

(54) PUBLISHER-SUBSCRIBER COMMUNICATION ARCHITECTURE FOR A VEHICLE

(71) Applicant: Rivian IP Holdings, LLC, Irvine, CA (US)

(72) Inventor: Nicolas DIKEN, Palo Alto, CA (US)

(21) Appl. No.: 19/047,544

(22) Filed: Feb. 6, 2025

Related U.S. Application Data
(60) Provisional application No. 63/643,408, filed on May 6, 2024.

(51) Int. Cl. H04L 67/55; G06F 9/52; H04L 12/40

(52) U.S. Cl. CPC H04L 67/55; G06F 9/52; H04L 12/40006; H04L 2012/40273

(57) ABSTRACT

A vehicle includes a plurality of physical devices and a plurality of processing devices including a plurality of publisher devices and a plurality of subscriber devices, each publisher device of the plurality of publisher devices having at least one physical device of the plurality of physical devices connected thereto. A vehicle bus is connected to the plurality of processing devices. A router is configured to: receive a write request from a publisher executing on a publisher device of the plurality of publisher devices, the write request including a topic and one or more sub-topics of the topic; determine that (a) one or more subscribers executing on one or more subscriber devices of the plurality of subscriber devices are associated with the topic and the one or more sub-topics; and in response to (a), notify the one or more subscribers of the write request.

### RELATED APPLICATION

This application claims the benefit of U.S. Provisional Application Ser. No. 63/643,408 filed May 6, 2024, and entitled PUBLISHER-SUBSCRIBER COMMUNICATION ARCHITECTURE FOR A VEHICLE.

### INTRODUCTION

The present disclosure relates to the exchange of data between components of a vehicle.

### SUMMARY

The present disclosure describes an approach for communicating messages between components of a vehicle. In one aspect, a vehicle includes a plurality of physical devices configured to receive a physical input or produce a physical output; a plurality of processing devices including a plurality of publisher devices and a plurality of subscriber devices, at least a portion of the plurality of publisher devices and the plurality of subscriber devices having at least one physical device of the plurality of physical devices connected thereto; and a vehicle bus connected to the plurality of processing devices. The plurality of processing devices execute a router that is configured to: receive a write request from a publisher executing on a publisher device of the plurality of publisher devices, the write request including a topic and one or more sub-topics of the topic; determine that (a) one or more subscribers executing on one or more subscriber devices of the plurality of subscriber devices are associated with the topic and the one or more sub-topics; and in response to (a), notify the one or more subscribers of the write request.

### BRIEF DESCRIPTION OF THE DRAWINGS

FIG. 1A illustrates an example vehicle that may be operated in accordance with certain embodiments.

FIG. 1B illustrates a chassis of a vehicle having multiple drive units that may be operated in accordance with certain embodiments.

FIG. 2 is a schematic block diagram of components for operating the vehicle in accordance with certain embodiments.

FIG. 3 is schematic diagram showing a system for exchanging data between components of a vehicle according to a publisher-subscriber model in accordance with certain embodiments.

FIG. 4 is a diagram illustrating a page for exchanging data between components of a vehicle according to a publisher-subscriber model in accordance with certain embodiments.

FIG. 5 is a process flow diagram of a method for setting up publication and subscription in accordance with certain embodiments.

FIG. 6 is a process flow diagram of a method for exchanging data between components of a vehicle according to a publisher-subscriber model in accordance with certain embodiments.

### DETAILED DESCRIPTION

A modern vehicle includes many electronic components that communicate with one another in real time. Efficient communication between components using the approach described herein is achieved using a router that manages communication between publishers and subscribers executing on processing devices connected to one another by a vehicle network. Subscribers are associated with topics and possibly one or more sub-topics of a topic. Publishers write to allocated pages that are labeled with a topic and possibly one or more sub-topics. The router identifies subscribers for the topic and possibly the one or more sub-topics and notifies the subscribers, which then request to read the page. The use of sub-topics enables subscribers to be more selective regarding messages received from a publisher, reducing unnecessary processing and congestion of the vehicle network.

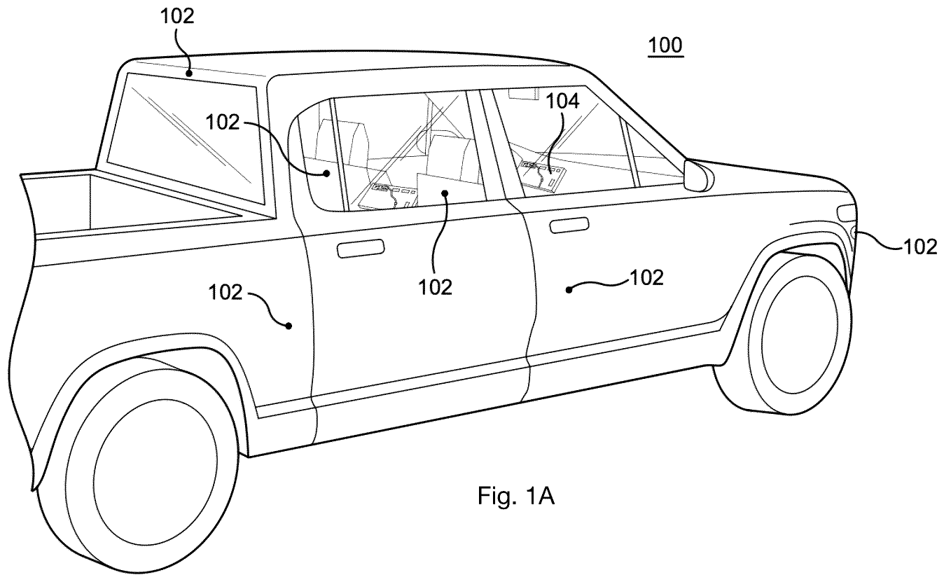

FIG. 1A illustrates an example vehicle 100. As seen in FIG. 1A, the vehicle 100 has multiple exterior cameras 102 and one or more front displays 104. Each of these exterior cameras 102 may capture a particular view or perspective on the outside of the vehicle 100. The images or videos captured by the exterior cameras 102 may then be presented on one or more displays in the vehicle 100, such as the one or more front displays 104, for viewing by a driver.

Referring to FIG. 1B, the vehicle 100 may include a chassis 106 including a frame 108 providing a primary structural member of the vehicle 100. The frame 108 may be formed of one or more beams or other structural members or may be integrated with the body of the vehicle (i.e., unibody construction).

In embodiments where the vehicle 100 is a battery electric vehicle (BEV) or possibly a hybrid vehicle, a large battery 110 is mounted to the chassis 106 and may occupy a substantial (e.g., at least 80 percent) of an area within the frame 108. For example, the battery 110 may store from 100 to 200 kilowatt hours (kWh). The battery 110 may be a lithium-ion battery or other type of rechargeable battery. The battery may be substantially planar in shape.

Power from the battery 110 may be supplied to one or more drive units 112. Each drive unit 112 may be formed of an electric motor and possibly a gear train providing a gear reduction. In some embodiments, there is a single drive unit 112 driving either the front wheels or the rear wheels of the vehicle 100. In another embodiment, there are two drive units 112, each driving either the front wheels or the rear wheels of the vehicle 100. In yet another embodiment, there are four drive units 112, each drive unit 112 driving one of four wheels of the vehicle 100.

Power from the battery 110 may be supplied to the drive units 112 by power electronics 114 of each drive unit 112. The power electronics 114 may include inverters configured to convert direct current (DC) from the battery 110 into alternating current (AC) supplied to the motors of the drive units 112. The power electronics 114 further facilitate operation of the motors of the drive units as generators to provide regenerative braking. The power electronics 114 further facilitate the transfer of regenerative current to the battery 110.

The drive units 112 are coupled to two or more hubs 116 to which wheels may mount. Each hub 116 includes a corresponding brake 118, such as the illustrated disc brakes. Each hub 116 is further coupled to the frame 108 by a suspension 120. The suspension 120 may include metal or pneumatic springs for absorbing impacts. The suspension 120 may be implemented as a pneumatic or hydraulic suspension capable of adjusting a ride height of the chassis 106 relative to a support surface. The suspension 120 may include a damper with the properties of the damper being either fixed or adjustable electronically.

In the embodiment of FIG. 1B and in the discussion below, the vehicle 100 is a battery electric vehicle. However, the systems and methods disclosed herein may be used for any type of vehicle, including vehicles powered by an internal combustion engine (ICE), hybrid drivetrain, hydrogen fuel cell drivetrain, or other type of drivetrain that may have a portion that is idled during some modes of operation. For example, a front or rear differential of an all-wheel drive vehicle. In another example, in a hybrid drive train, an idled drive unit including an electric motor may be heated with waste heat from an ICE according to the approaches described herein.

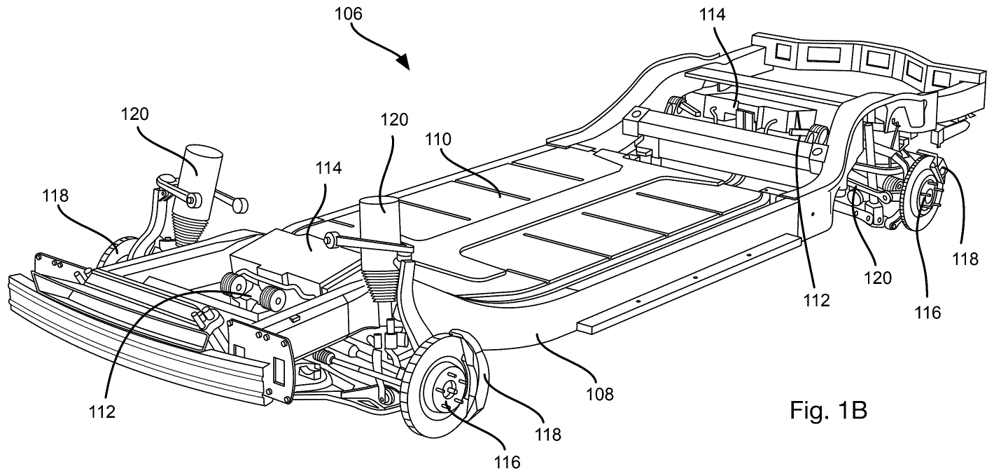

FIG. 2 illustrates example components of the vehicle 100 of FIG. 1A. As seen in FIG. 2, the vehicle 100 includes the cameras 102, the one or more front displays 104, a user interface 200, one or more sensors 202, a motion sensor 204, and a location system 206. The one or more sensors 202 may include ultrasonic sensors, radio detection and ranging (RADAR) sensors, light detection and ranging (LIDAR) sensors, or other types of sensors. The location system 206 may be implemented as a global positioning system (GPS) receiver. The user interface 200 allows a user, such as a driver or passenger in the vehicle 100, to provide input.

The components of the vehicle 100 may include one or more temperature sensors 208. The temperature sensors 208 may include sensors configured to sense an ambient air temperature, temperature of the battery 110, temperature of power electronics 114, temperature of each drive unit 112 and/or each motor of each drive unit 112, temperature of coolant fluid entering or leaving a coolant system, temperature of oil within a drive unit 112, or the temperature of any other component of the vehicle 100.

The components of the vehicle 100 may include a friction braking system 210. The friction braking system 210 may include any components of a hydraulic braking system, such as a rotor, brake pads, calipers, caliper pistons, a master cylinder coupled to the brake pedal and coupled to the caliper pistons by brake lines. The friction braking system 210 may further include a pump and/or valves for automatically applying hydraulic pressure to the caliper pistons. The friction braking system 210 may be implemented as a drum braking system or any friction braking system known in the art.

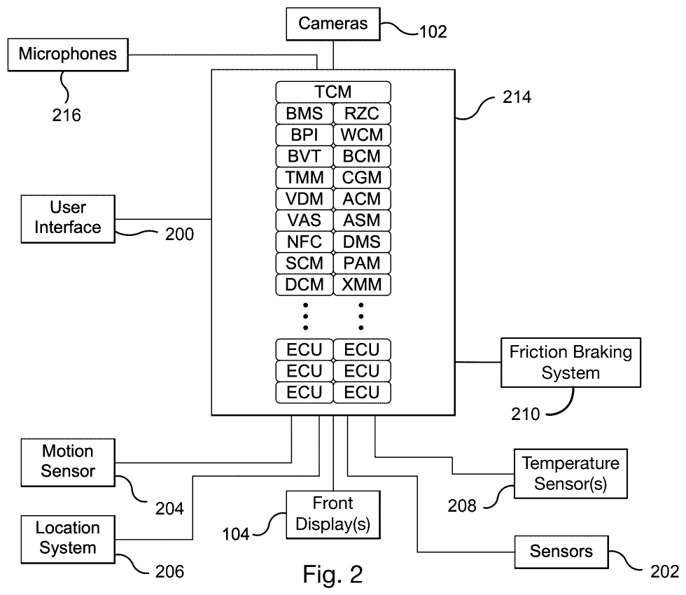

A control system 214 executes instructions to perform at least some of the actions or functions of the vehicle 100, including the functions described in relation to FIGS. 3 to 6. For example, as shown in FIG. 2, the control system 214 may include one or more electronic control units (ECUs) configured to perform at least some of the actions or functions of the vehicle 100, including the functions described in relation to FIGS. 3 to 6. In certain embodiments, each of the ECUs is dedicated to a specific set of functions. Each ECU may be a computer system and each ECU may include functionality described below.

Certain features of the embodiments described herein may be controlled by a Telematics Control Module (TCM) ECU. The TCM ECU may provide a wireless vehicle communication gateway to support functionality such as, by way of example and not limitation, over-the-air (OTA) software updates, communication between the vehicle and the internet, communication between the vehicle and a computing device, in-vehicle navigation, vehicle-to-vehicle communication, communication between the vehicle and landscape features (e.g., automated toll road sensors, automated toll gates, power dispensers at charging stations), or automated calling functionality.

Certain features of the embodiments described herein may be controlled by a Central Gateway Module (CGM) ECU. The CGM ECU may serve as the vehicle's communications hub that connects and transfer data to and from the various ECUs, sensors, cameras, microphones, motors, displays, and other vehicle components. The CGM ECU may include a network switch that provides connectivity through Controller Area Network (CAN) ports, Local Interconnect Network (LIN) ports, and Ethernet ports. The CGM ECU may also serve as the master control over the different vehicle modes (e.g., road driving mode, parked mode, off-roading mode, tow mode, camping mode), and thereby control certain vehicle components related to placing the vehicle in one of the vehicle modes.

In various embodiments, the CGM ECU collects sensor signals from one or more sensors of vehicle 100. For example, the CGM ECU may collect data from cameras 102, sensors 202, motion sensor 204, location system 206, and temperature sensors 208. The sensor signals collected by the CGM ECU are then communicated to the appropriate ECUs for performing, for example, the operations and functions described below.

The control system 214 may also include one or more additional ECUs, such as, by way of example and not limitation: a Vehicle Dynamics Module (VDM) ECU, an Experience Management Module (XMM) ECU, a Vehicle Access System (VAS) ECU, a Near-Field Communication (NFC) ECU, a Body Control Module (BCM) ECU, a Seat Control Module (SCM) ECU, a Door Control Module (DCM) ECU, a Rear Zone Control (RZC) ECU, an Autonomy Control Module (ACM) ECU, an Autonomous Safety Module (ASM) ECU, a Driver Monitoring System (DMS) ECU, and/or a Winch Control Module (WCM) ECU.

If vehicle 100 is an electric vehicle, one or more ECUs may provide functionality related to the battery pack of the vehicle, such as a Battery Management System (BMS) ECU, a Battery Power Isolation (BPI) ECU, a Balancing Voltage Temperature (BVT) ECU, and/or a Thermal Management Module (TMM) ECU. In various embodiments, the XMM ECU transmits data to the TCM ECU (e.g., via Ethernet, etc.). Additionally or alternatively, the XMM ECU may transmit other data (e.g., sound data from microphones 216, etc.) to the TCM ECU.

The ECUs may include one or more ECUs that are configured to control the friction braking system 210. For example, the ECUs may include a traction control module, a stability control system, automated emergency braking (AEB) module, anti-lock braking system (ABS), adaptive cruise control module (ACC), and/or an automated driving assistance system (ADAS). The traction control module controls braking and acceleration to control wheel slip according to any approach known in the art. The traction control module may also control the torque applied at each wheel, i.e., torque vectoring. The stability control system controls braking and acceleration in order to avoid rollovers of the vehicle 100 according to any approach known in the art. The AEB module stops the vehicle 100 in a controlled manner response to predicted collisions according to any approach known in the art. The ABS modulates braking to maintain traction. The ACC maintains a speed of the vehicle while also maintaining a prescribed following distance with respect to other vehicles. The ADAS controls steering, acceleration, and braking of the vehicle 100 to arrive at a destination according to any self-driving approach known in the art.

Referring to FIG. 3, the control system 214 or any of the above-referenced components thereof may be implemented using the illustrated architecture. For example, an ECU that is part of the control system 214 may include multiple components that communication with one another using the illustrated architecture. Specifically, the architecture may be used to exchange information between components of the vehicle 100. For example, any of the illustrated components of the control system 214, or sub-components of a component of the control system 214, may be implemented as separate devices that communicate with one another over a vehicle network 300. Likewise, any component (drive unit 112, suspension 120, etc.) incorporating a sensor may communicate with the control system 214 over the vehicle network 300. The vehicle network 300 may be embodied as a bus local to a single circuit board, a control area network (CAN) bus, ethernet network, or any other type of network. The vehicle network 300 used to implement the illustrated architecture may be a wired or wireless network. The vehicle network 300 may also be implemented by other types of communication, such as communication between different processor cores on a common computer chip (e.g., using a shared memory, on-chip bus, or other communication modality).

Any of the above listed components may be embodied as a device including a processor 302 that may include one or more processor cores 304. Any of the above-listed components may include a memory 306 storing one or more executable instances 308 that may be executed as separate processes by the processor 302. The executable instances 308 may be applications or other type of executable. The processor 302 may further execute an operating system.

The processor 302 of a component may be coupled to a physical device 310 that is controlled by the processor 302 or provides data to the processor 302. Each physical device 310 either receives a physical input or produces a physical output. The physical device 310 may be an input device, such as a button, touch screen, microphone, camera, or other input device. The physical device 310 may be an output device, such as a light, screen, speaker, haptic device, or any other output device. The physical device 310 may be an actuator, such as a motor, switch, valve, solenoid, or other component controlling the physical operation of the vehicle. The physical device may be a sensor sensing any aspect of operation of the vehicle, such as a state of a drive unit 112, suspension 120, the battery 110, the control system 214, or any other component of the vehicle 100.

A processor 312 connected to the vehicle network 300 and having a corresponding memory 314 may execute a router 316. The router 316 may facilitate the exchange of messages between processors 302. For example, readings from a sensor or inputs to an input device may be consumed by multiple other processors 302. Instructions for an actuator or an output to be output from an output device may be received from multiple other processors 302. The router 316 may facilitate the efficient and timely distribution of messages between the processors 302

The router 316 may include a broker 318 that implements logic for managing the communication of messages from a source of the message (“publisher”) and a recipient of the message (“subscribers”). The broker 318 may be an in-sync replication (ISR) broker according to any approach known in the art.

A processor 302 (e.g., a core 304 of a processor 302) executing a publisher may be referred to as a publisher device. A processor 302 (e.g., a core 304 of a processor 302) executing a subscriber may be referred to as a subscriber device. Additionally, a processor 302 may function as both a publisher device and a subscriber device. As used herein, a publisher and a subscriber may be a process executing on a processor 302 (e.g., a process being executed by a core 304 of a processor 302, such as a process executing an instance 308). In the following description, communication between the router 316 and the subscribers and publishers shall be understood as being conducted over the vehicle network 300.

The router 316 may route messages according to topic/sub-topic subscription table 320 (“the table 320”). The table 320 may be implemented as an array in a memory or other data structure storing data as a table. As discussed in further detail below, a message from a publisher may be marked with a topic and possibly a sub-topic of the topic. Although only a two-level hierarchy is discussed herein, a hierarchy of topics, sub-topics, sub-sub-topics, etc. up to any number of hierarchical levels may be implemented. The table 320 may map each topic and sub-topic to one or more subscribers. A subscriber may be identified in the table 320 by some or all of a unique subscriber identifier, an address on the vehicle network 30, an identifier of the processor 302 executing the subscriber, an identifier of a core 304 of the processor 302, an identifier of a process that implements the subscriber (e.g., a process identifier of the operating system executing on the processor 302), or other information.

The table 320 may represent at least the following scenarios: (a) a subscriber identifier is subscribed to a topic and all sub-topics of a topic (e.g., a wildcard designation) and (b) a subscriber identifier is subscribed to a topic and specific sub-topics amounting to less than all of the sub-topics of the topic.

The router 316 may operate in conjunction with an allocator 322 managing a page pool 324. The allocator 322 may facilitate the assignment of pages 326 from the page pool 324 and the freeing of pages 326 for subsequent assignment. The router 316 may store messages from a publisher in a page 326 and facilitate reading of the page by subscribers of the publisher. The pages 326 may be of multiple types, such as having different amounts of memory for storing messages (e.g., small, medium, and large). Pages 326 may have a custom size for messages from particular publishers or types of publishers.

The router 316 may maintain one or more queues listing identifiers of subscribers in association with identifiers of pages 326 to be read by the subscribers. For example, the router 316 may maintain a processor queue 328. The processor queue 328 may include entries including, for example, an identifier of a page 326, an identifier of a processor 302, and possibly an identifier core 304 of a processor 302 executing a subscriber of the page 326. The router 316 may further maintain a subscriber queue 330, the subscriber queue may list an identifier of a page 326 and an identifier of a subscriber of the page 326, such as a process identifier of the subscriber.

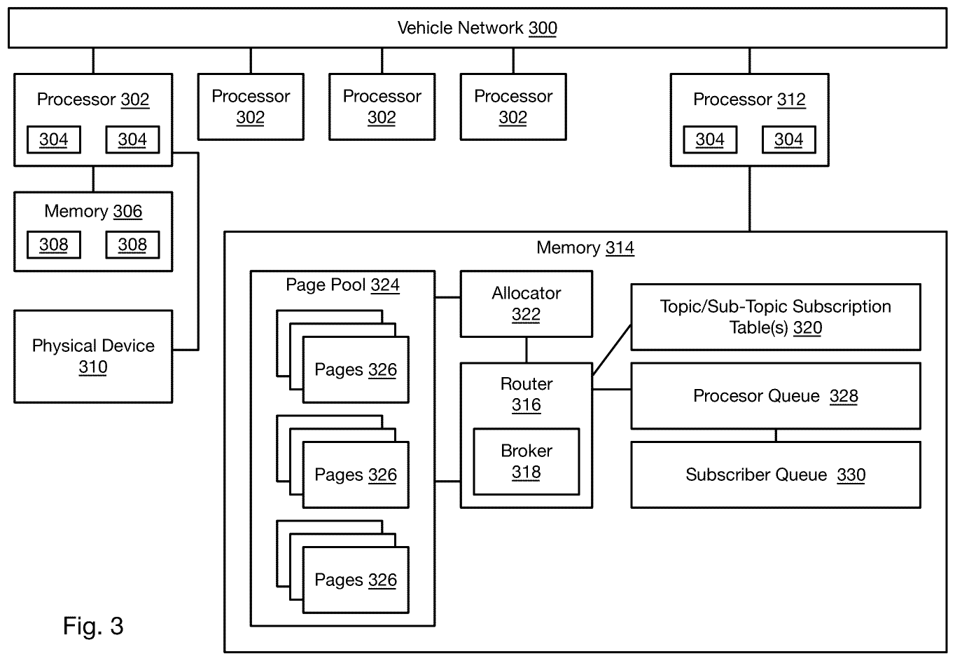

FIG. 4 illustrates an example page 326. The page 326 may store one or more topics 400 and one or more sub-topics 402. Accordingly, each subscriber associated with the one or more topics 400 and the one or more sub-topics 402 in the table 320 will be notified by the router 316 upon publication of the page 326.

The page 326 may include one or more data structures to facilitate the asynchronous access of the page 326 by the subscriber and one or more publishers. For example, a write mutex 404 may be used by the publisher to lock the page 326 while it is being written to prevent premature reading. An active read semaphore 406 may indicate a number of subscribes that are actively reading the page 326. For example, deleting of the page 326 may be prevented until the number of active readers is zero. A possible read semaphore 408 may list the total number of subscribers associated with the one or more topics 400 and the one or more sub-topics 402 in the table 320. The number may be decremented by one each time a unique one of these subscribers reads the page 326. The page 326 may therefore be released for reuse when the possible read semaphore 408 lists zero possible readers.

The possible read semaphore 408 may alternatively list each subscriber identifier of the subscribers and include an indicator of whether a particular subscriber has read the page 326. The page 326 may then be released once the indicators for all subscribers indicate that reading has been performed. In some embodiments, the page 326 is also released after a timeout period has elapsed, e.g., a timeout period following a write request, a timeout period following a last read of the page 326, or a timeout period following some other starting point.

The page 326 may store a payload 410, such as the content of the message transmitted by the publisher. The payload may be an instruction for an actuator, an output to be output from an output device, a reading from a sensor, or an input from an input device. The payload 410 may be a buffer or a pointer to a buffer. The sizes of the payloads 410 of the pages 326 may differ.

A topic 400 may include identification information, such as an identifier 412, ethernet address 414 in the vehicle network 300 for the processor 302 executing the publisher (or assigned to the publisher itself), and a kernel identifier 416 of a kernel executing the publisher.

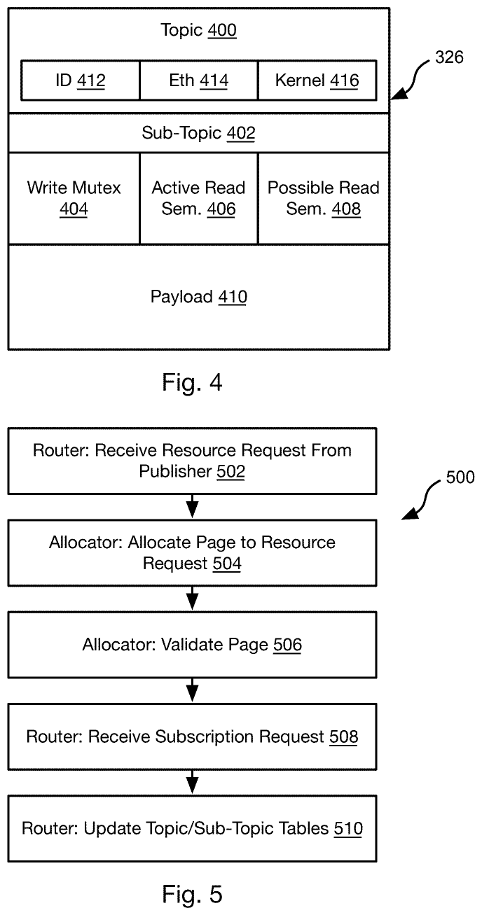

FIG. 5 illustrates a method 500 for setting up publication and subscription. The method 500 may include the router 316 receiving, at step 502, a resource request from the publisher. The resource request may be a request for allocation of a page 326 and may specify the type (e.g., size) of the page 326 that is requested. In response, the router 316 may instruct the allocator 322 to allocate the page 326, and the allocator 322 does so at step 504. Instructions to allocate a page 326 may be queued until a page of the required type is available. Where memory resources are available and a page of the required type is not available, a page 326 may be instantiated and allocated to the publisher. Step 504 may include validating, at step 506, the page 326 allocated at step 504.

The method 500 may include receiving, at step 508, by the router 316, a subscription request from a subscriber, the subscription request including one or more topics and zero or more sub-topics of the one or more topics. In response, the router 316 may update, at step 510, the table 320 to associate the identifier of the subscriber with the one or more topics and the zero-or more sub-topics of the one or more topics.

Steps 508 and 510 may be performed for multiple subscribers. For example, a first subscriber may request subscription to a topic and all sub-topics of the topic, and a second subscriber may request subscription to the topic and a portion of the sub-topics. In another example, a first subscriber may request subscription to a topic and a first portion of the sub-topics of the topic, and a second subscriber may request subscription to the topic and a second portion of the sub-topics that is different from the first portion (e.g., that includes one or more sub-topics that are not in the first portion). Accordingly, some write requests referencing the topic and a sub-topic of the first portion will invoke a notification to the first subscriber, but the router 316 will refrain from notifying the second subscriber.

Using this approach, the subscriber is relieved of the burden of reading and dismissing messages that are not relevant to the subscriber. For example, a first subscriber may coordinate operation with a publisher, whereas a second subscriber need only receive messages relating to errors or messages relating to malfunction of the publisher.

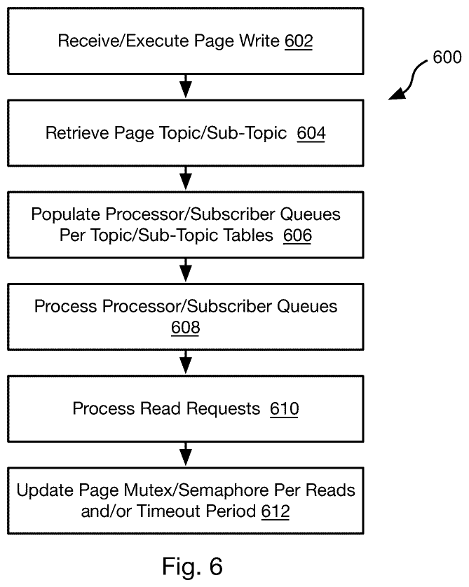

FIG. 6 is a process flow diagram of a method for exchanging data between components of a vehicle, e.g., publishers and subscribers as defined above. The method 600 may be performed by the router 316. The router 316 may receive, at step 602, a write request from a publisher. The write request may include a page write that references an identifier of a page 326. The page write may include some or all of the items of information shown in FIG. 4. The page write from step 602 may be preceded with allocation of the page 326 identified in the write request to the publisher identifier of the publisher that generated the write request of step 602. Step 602 may further include executing the page write by writing data from the page write to the page 326 identified in the page write.

The router 316 may retrieve one or more topics and possibly one or more sub-topics of the one or more topics from the write request at step 604. The router may then populate, at step 606, the processor queues 328 and subscriber queues 330 corresponding to those subscribers that are associated with the one or more topics and possibly one or more sub-topics. For example, for each subscriber associated with the one or more topics and possibly one or more sub-topics, an entry in the processor queue 328 may identify the processor 302 and/or core 304 executing the subscriber (e.g., network address, processor identifier, and possibly a core identifier) and identifier of the page 326 written at step 602. An entry in the subscriber queue 330 may include an identifier of the subscriber, e.g., process identifier an identifier of the page 326 written at step 602. An entry in the subscriber queue 330 may be associated with a corresponding entry in the processor queue 328, e.g., the entry in the processor queue 328 including the identifier of the processor 302 and/or core 304 executing the subscriber.

The router 316 may then process the processor queues 328 and subscriber queues 330 at step 608. Processing of the processor queues 328 and subscriber queues 330 may be an ongoing process that is performed concurrently (e.g., using context switching) with other steps of the method 600. Processing of the processor queues 328 and subscriber queues 330 may include, for each entry in the processor queue 328, transmitting a notification to the processor 302 and/or core 304 identified in the entry. The notification may be in the form of a remote procedure call (RPC), interrupt request, or message according to any networking protocol known in the art. The notification may be placed in a queue of the processor 302 and/or core 304 identified in the entry. The notification may include an identifier of the page 326 written at step 602. The notification may include, or reference, one or more entries in the subscriber queue 330 corresponding to the entry in the processor queue 328. Upon receiving the notification, the processor 302 and/or core 304, may retrieve the corresponding one or more entries in the subscriber queue 330 and create entries in a local queue of the processor 302 and/or core 304. The entries may reference the subscriber or be created in a local queue that is exclusive to the subscriber. The processor 302 and/or core 304 may then process the entries in the local queue by generating an interrupt or otherwise invoking processing of the entries by the subscriber. The subscriber may process the entries in the local queue by transmitting read requests to the router 316, such as for each entry of the entries. Each read request for an entry may reference the identifier of the subscriber and the page identifier from the entry. Each read request may further identify the processor 302 and/or core 304 executing the subscriber, such as in the form of a network address or other identifier.

The router 316 may process, at step 610, each read request. Processing read requests may include transmitting at least the payload 410 of the page 326 written at step 602 to the subscriber over the vehicle network 300. Multiple read requests for the same page 326 may be processed concurrently (e.g., multicast) or in an interleaved manner.

Step 610 may be performed along with step 612 in which one or more mutexes and/or semaphores of the page 326 are updated for page read request as described above with respect to FIG. 4. For example, the active read semaphore 406 may be updated each time processing of a read request begins and each time processing of a read request completes. Semaphore 408 may be updated after processing of each read request completes.

The descriptions of the various embodiments of the present disclosure have been presented for purposes of illustration. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

In the preceding, reference is made to embodiments presented in this disclosure. However, the scope of the present disclosure may exceed the specific described embodiments. Instead, any combination of the features and elements, whether related to different embodiments, is contemplated to implement and practice contemplated embodiments. Furthermore, although embodiments disclosed herein may achieve advantages over other possible solutions or over the prior art, the embodiments may achieve some advantages or no particular advantage. Thus, the aspects, features, embodiments and advantages discussed herein are merely illustrative.

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.”

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by one or more computer processing devices. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Certain types of storage devices that include these mediums include: diskette, hard disk, random access memory (RAM), read only memory (ROM), erasable programmable read only memory (EPROM or Flash memory), static random access memory (SRAM), compact disc read only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, refers to non-transitory storage rather than transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but the storage device remains non-transitory during these processes because the data remains non-transitory while stored.

While the foregoing is directed to embodiments of the present disclosure, other and further embodiments may be devised without departing from the basic scope thereof, and the scope thereof is determined by the claims that follow.

What is claimed is:

1. A vehicle comprising:
a plurality of physical devices configured to receive a physical input or produce a physical output;
a plurality of processing devices including a plurality of publisher devices and a plurality of subscriber devices, at least a portion of the plurality of publisher devices and the plurality of subscriber devices being connected to at least one physical device of the plurality of physical devices; and
a vehicle bus connected to the plurality of processing devices;
wherein the plurality of processing devices execute a router, the router configured to:
receive a write request from a publisher executing on a publisher device of the plurality of publisher devices, the write request including a topic and one or more sub-topics of the topic;
determine that (a) one or more subscribers executing on one or more subscriber devices of the plurality of subscriber devices are associated with the topic and the one or more sub-topics; and
in response to (a), notify the one or more subscribers of the write request.

2. The vehicle of claim 1, wherein the router is further configured to, in response to (a) refrain from notifying subscribers executing on the plurality of subscriber devices that are (i) associated with the topic, and (ii) not associated with the one or more sub-topics of the write request.

3. The vehicle of claim 1, wherein the router is further configured to:
write data from the write request to a page; and
process read requests for the page from the one or more subscribers.

4. The vehicle of claim 3, wherein the page includes a semaphore, the router being further configured to update the semaphore in response to each read request from the one or more subscribers.

5. The vehicle of claim 4, wherein the router is further configured to release the page for reuse when the semaphore indicates that all of the one or more subscribers have read the page.

6. The vehicle of claim 1, wherein the router is further configured to notify each subscriber of the one or more subscribers of the write request by:
notifying a subscriber device of the plurality of subscriber devices executing each subscriber; and
and notifying each subscriber.

7. The vehicle of claim 1, wherein:
the plurality of physical devices include at least one of a button, a touch screen, a microphone, or a camera; and
the write request includes an output of a physical device of the plurality of physical devices.

8. The vehicle of claim 1, wherein:
the plurality of physical devices include at least one of a speaker, a screen, or a light; and
the write request includes an input to a physical device of the plurality of physical devices.

9. The vehicle of claim 1, wherein:
the plurality of physical devices include at least one of an motor, a switch, a valve, or a solenoid; and
the write request includes an input to a physical device of the plurality of physical devices.

10. The vehicle of claim 1, wherein:
the plurality of physical devices include sensors configured to sense operation of the vehicle; and
the write request includes an output of a physical device of the plurality of physical devices.

11. A method comprising:
providing a plurality of physical devices of a vehicle configured to receive a physical input or produce a physical output;
providing a plurality of processing devices including a plurality of publisher devices and a plurality of subscriber devices, at least a portion of the plurality of publisher devices and the plurality of subscriber devices being connected to at least one physical device of the plurality of physical devices;
providing a vehicle bus connected to the plurality of processing devices;
receiving, by a router executing on the plurality of processing devices, a write request from a publisher executing on a publisher device of the plurality of publisher devices, the write request including a topic and one or more sub-topics of the topic;
determining, by the router, that (a) one or more subscribers executing on one or more subscriber devices of the plurality of subscriber devices are associated with the topic and the one or more sub-topics; and
in response to (a), notifying, by the router, the one or more subscribers of the write request.

12. The method of claim 11, further comprising, in response to (a) refraining, by the router, from notifying subscribers executing on the plurality of subscriber devices that are (i) associated with the topic, and (ii) not associated with the one or more sub-topics of the write request.

13. The method of claim 11, further comprising:
writing, by the router, data from the write request to a page; and
process read requests for the page from the one or more subscribers.

14. The method of claim 13, wherein the page includes a semaphore, the method further comprising updating, by the router, the semaphore in response to each read request from the one or more subscribers.

15. The method of claim 14, further comprising, releasing, by the router, the page for reuse when the semaphore indicates that all of the one or more subscribers have read the page.

16. The method of claim 11, further comprising notifying, by the router, each subscriber of the one or more subscribers of the write request by:
notifying a subscriber device of the plurality of subscriber devices executing each subscriber; and
and notifying each subscriber.

17. The method of claim 11, wherein:
the plurality of physical devices include at least one of a button, a touch screen, a microphone, or a camera; and
the write request includes an output of a physical device of the plurality of physical devices.

18. The method of claim 11, wherein:
the plurality of physical devices include at least one of a speaker, a screen, or a light; and
the write request includes an input to a physical device of the plurality of physical devices.

19. The method of claim 11, wherein:
the plurality of physical devices include at least one of an actuator, a switch, a valve, or a solenoid; and
the write request includes an input to a physical device of the plurality of physical devices.

20. The method of claim 11, wherein:
the plurality of physical devices include sensors configured to sense operation of the vehicle; and
the write request includes an output of a physical device of the plurality of physical devices.
